(19) United States
(12) Patent Application Publication
(10) Pub. No.: US 2011/0091732 A1
(43) Pub. Date: Apr. 21, 2011

(54) POLYAMIC ACID RESIN COMPOSITION AND POLYIMIDE FILM PREPARED THEREFROM

(75) Inventors: Charng-Shing Lu, Hsinchu City (TW); Chyi-Ming Leu, Hsinchu County (TW); Jinn-Shing King, Hsinchu County (TW); Tzong-Ming Lee, Hsinchu City (TW)

(73) Assignee: INDUSTRIAL TECHNOLOGY RESEARCH INSTITUTE, Hsinchu County (TW)

(21) Appl. No.: 12/775,405

(22) Filed: May 6, 2010

(30) Foreign Application Priority Data
Oct. 15, 2009 (TW) 098134919

(51) Int. Cl. C08K 3/36; B32B 27/08; B32B 15/08

(52) U.S. Cl. 428/458; 524/493; 428/473.5

(57) ABSTRACT

A polyamic acid resin composition, and a polyimide film and laminate prepared therefrom are provided. The polyamic acid resin composition includes a polyamic acid resin, a solvent, and a polar aprotic solution containing nanoscale silica, with surface hydroxyl groups, modified by a surface modification agent. Particularly, the surface modification agent has a structure represented by formula (I):

R¹—Si—(OR²)₃ formula (I)
wherein, R¹ is an aliphatic group or an aryl group, and R² is a C₁₋₈ alkyl group.

### CROSS REFERENCE TO RELATED APPLICATIONS

This application is based upon and claims the benefit of priority from the prior Taiwan Patent Application No. 098134919, filed on Oct. 15, 2009, the entire contents of which are incorporated herein by reference.

### BACKGROUND OF THE INVENTION

1. Field of the Invention

The invention relates to a polyamic acid resin composition and a polyimide film, and more particularly to a polyamic acid resin composition and a polyimide film with high transparency, high modulus, and high dimensional stability.

2. Description of the Related Art

Along with the rapid development and availability of network communication and portable electronic products with high performance, high-speed transmission, compact, and light weight conveniences, demand for flexible substrates with improved precision, high density, and multi-function ability have increased. Currently, flexible substrate materials meet the needs of products with high-speed transmission and high stabilization. Desired characteristics of flexible substrate materials include high thermal resistance, low moisture absorption, high dimensional stability, and superior electronic specifications.

Polyimide has been widely used as molding materials, composite materials and electric materials in various fields due to excellent thermal resistance mechanical properties and electronic specifications. However, conventional polyimide films have high hygroscopicity of more than 1.5%, inferior weatherability and low dimensional stability (more than 0.1%), thereby limiting accuracy when applied in fine wire manufacturing. Further, due to a low modulus, conventional polyimide films are not suitable for carrying active or passive elements thereon.

In general, an inorganic filler is added to a polyamic acid resin composition to reduce thermal expansion coefficient and hygroscopicity of a polyimide film formed therefrom. JP2003192891A discloses a method which mixes a polyimide resin with a submicron-dimensional or micro-dimensional silica powder (such as talc or mica). TW Pat. 1220901 also discloses a similar method of JP2003192891A. However, although thermal expansion coefficient of the polyimide resin is reduced when compared to other conventional methods, the obtained polyimide film exhibits inferior transparency. Further, the additive amount of the silica powder has to be less than 20 wt % in order to reduce the brittleness thereof.

US 2007/0009751A1 discloses a method to improve dimensional stability, hygroscopicity, transparency and thermal expansion coefficient of polyamic acid resin by mixing a nanoscale silica powder therewith. Since the surface of nanoscale silica powder does not be modified by a modifier, the additive amount of the nanoscale silica powder has to be not more than 15 wt %, resulting in inferior dimensional stability and hygroscopicity of the polyamic acid resin composition.

JP2002-249581A discloses a method to form a polyimide film by mixing clay with polyamic acid resin. The method reduces thermal expansion coefficient and increase the transparency of polyimide films formed therefrom. However, because the ion residue of clay is high (sodium ion content of more than 80 ppm), the polyimide film has inferior electrical reliability due to ion migration.

TW 200535168 discloses a method for forming a polyimide film, which includes the steps of reacting tetraethoxysilane (TEOS), and tetramethoxysilane (or phenyltriethoxysilane) using a sol-gel process to obtain a nano-scale silica with a net structure, and mixing the net structured nano-scale silica with polyamic acid resin to form a polyimide film. The obtained polyimide film has reduced thermal expansion coefficient and exhibits high transparency when compared to conventional methods. However, the obtained polyimide film is also less reproducible and exhibits heat shrinkage, especially in high silica content (>20 wt %).

### BRIEF SUMMARY OF THE INVENTION

An exemplary embodiment of a polyamic acid resin composition is provided and includes: a polyamic acid resin; a solvent; and a polar aprotic solution containing nanoscale silica, with surface hydroxyl groups, modified by a surface modification agent, wherein the nanoscale silica, with surface hydroxyl groups, modified by a surface modification agent is uniformly distributed in a polar aprotic solvent and has an average particular size of 5-80 nm, wherein the surface modification agent has a structure represented by formula (I):

R¹Si—(R²)₃ formula (I)

wherein, R¹ is an aliphatic group or an aryl group, and R² is a C₁₋₈ g alkyl group.

An exemplary embodiment of a polyimide film is provided and includes a product fabricated by reacting components of the aforementioned polyamic acid resin composition using a thermal imidization process. The obtained polyimide film can be used as a part of a laminate or serve as a protection film of an electronic device.

An exemplary embodiment of a laminate, such as a copper foil laminate or a double-sided flexible copper clad laminate, is provided and includes the aforementioned polyimide film. The polyimide film can be disposed on a polymer film, copper foil, aluminium foil, stainless foil or nickel foil.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram illustrating a double-sided flexible copper clad laminate including the polyimide film of the invention.

FIG. 2 is a transmission electron microscope spectrum of a polyimide film fabricated by curing a polyamic acid resin composition which is prepared by mixing an unmodified silica (such as N-phenyl-3-aminopropyltrimethoxysilane) with a polyamic acid resin.

FIG. 3 is a transmission electron microscope spectrum of a polyimide film fabricated by curing the polyamic acid resin composition of Example 4.

FIG. 4 is a transmission electron microscope spectrum of a polyimide film fabricated by curing the polyamic acid resin composition of Example 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The polyamic acid resin composition of the invention includes a polyamic acid resin, a solvent, and a polar aprotic solution containing nanoscale silica, with surface hydroxyl groups, modified by a surface modification agent. The kind of polyamic acid resin of the invention is unlimited and can be conventional polyamic acid resin using for preparing polyimide film.

The polyamic acid resin of the invention can be prepared by reacting a dianhydride monomer (such as tetracarboxylic dianhydride) with a diamine monomer. The dianhydride monomer can be selected from a group consisting of pyromellitic dianhydride, 3,3,4,4-Biphenyl tetracarboylic dianhydride, s-BPDA), 1,4,5,8-Naphthalenetetracarboxylicdianhydride, 3,3,4,4-benzophenone -tetracarboxylic dianhydride, 4,4-oxydiphthalic anhydride, hydroquinnone diphtalic anhydride, 4,4-bisphenol A dianhydride, 2,2-bis -(3,4-dicarboxyphenyl)hexafluoropropane dianhydride, 1,3-dihydro-1,3-dioxo-5-isobenzofurancarboxylic acid phenylene ester, 3,4,4-Diphenylsulfone tetracarboxylic dianhydride and combinations thereof. Preferably, the dianhydride monomer can be selected from a group consisting of pyromellitic dianhydride, 3,3′, 4,4′-biphenyl tetracarboylic dianhydride, 1,4,5,8-Naphthalenetetracarboxylicdianhydride, 3,3′,4,4′-Benzophenone -tetracarboxylic dianhydride, 1,3-dihydro-1,3-dioxo-5-isobenzofurancarboxylic acid phenylene ester and combinations thereof. The diamine monomer can be selected from a group consisting of p-phenylene diamine, 4,4-oxydianiline, 3,4-Oxydianiline, 3,3′-dihydroxy-4,4-diamino-biphenyl, 4,4-diaminodiphenyl sulfone, 2,2-bis(4-aminophenyl)hexa-fluoropropane, 2,2-Bis(4-[4-aminophenoxy]phenyl)propane, 2,2-Bis(4-[3-aminophenoxy]phenyl)sulfone, 1,4-Bis(4-aminophenoxy)benzene, 1,3-Bis(4-aminophenoxy)benzene, 1,3-Bis(3-aminophenoxy)benzene, 4,4-Bis(4-aminophenoxy)biphenyl, 1,4-Bis(4-aminophenoxy)-2,5-di-t-butylbenzene, 4,4-Bis(4-aminophenoxy)benzophenone, diamino siloxane and combinations thereof. Preferably, the diamine monomer can be selected from a group consisting of p-phenylene diamine, 4,4-oxydianiline, 3,3′-dihydroxy-4,4-diamino-biphenyl, 4,4-diaminodiphenyl sulfone, and combinations thereof.

The surface modification agent has a structure represented by formula (I):

R¹—Si—(OR²)₃ formula (I)

wherein R¹ can be aliphatic group or aryl group, and R² is a C₁₋₈ alkyl group. In the invention, an “aliphatic group” is a non-aromatic moiety that may contain any combination of carbon atoms, hydrogen atoms, halogen atoms, oxygen, nitrogen or other atoms, and optionally contain one or more units of unsaturation, e.g., double and/or triple bonds. An “aryl group” refers to a mono- or polycyclic carbocyclic ring system having one or more aromatic rings including, but not limited to, phenyl, tolyl, naphthyl, tetrahydronaphthyl, biphenyl, phenanthryl, anthracyl and the like. The aryl group can include a “heteroaryl group” (mono- or polycyclic), containing one or two ring atoms which are additional heteroatoms independently selected from, for example, S, O and N, such as pyridyl, furyl, thienyl, imidazolyl, and the like.

In embodiments of the invention, R¹ can be a C₁₋₁₈ alkyl group, C₂₋₁₈ alkynylene group, C₂₋₁₈ alkenyl group, C₁₋₁₈ alkoxy group, C₂₋₁₈ ether group, C₁₋₁₈ alkylamino group, C₁₋₁₈ alkylthio group, C₂₋₁₈ isocyanate group, C₃₋₁₈ heteroalkyl group, C₃₋₂₀ aryl group, C₃₋₂₀ heteroaryl group, C₃₋₂₀ cycloaliphatic group, or C₃₋₂₀ cycloalkyl group. The surface modification agent of the invention can be, but is not limited to, propyltrimethoxysilane, prop yltriethoxys ilane, isobutyltrimethoxysilane, isobutyltriethoxysilane, octyltrimethoxysilane, octyltriethoxysilane, octadecyltrimethoxysilane, octadecyltriethoxysilane, N-phenyl-3-aminopropyltrimethoxysilane, phenyltrimethoxysilane, phenyltriethoxysilane, trimethoxysilylethylene, triethoxysilylethylene, allyltrimethoxysilane, allyltriethoxysilane, 3-glycidoxypropyltrimethoxysilane, 3-glycidoxypropyltriethoxysilane, 3-aminopropyltrimethoxysilane, 3-aminopropyltrimethoxysilane, aminoethylaminopropyltrimethoxysilane, aminoethylaminopropyltriethoxysilane, 3-isocyanatepropyltrimethoxysilane or 3-isocyanatepropyltriethoxysilane.

The polyamic acid resin composition can include a polar aprotic solvent such as N-methyl-2-pyrrolidone, N,N-dimethylacetamide, γ-butyrolactone, or combinations thereof. Further, a polyamic acid resin composition can include a co-solvent such as a co-solvent including xylene and toluene.

A key aspect of the invention is to replace the inorganic filler used in conventional polyamic acid resin compositions (such as talc used in JP 200319281A, mica used in TW Pat. 1220901, nanoscale silica powder used in US 2007/0009751A1, clay used in JP 2002-249581A, or organosiloxane used in TW 200535168) with the polar aprotic solution containing nanoscale silica, with surface hydroxyl groups, modified by a surface modification agent.

The polar aprotic solution containing nanoscale silica, with surface hydroxyl groups, modified by a surface modification agent includes a nanoscale silica (having surface hydroxyl groups and modified by a surface modification agent) uniformly distributed in a polar aprotic solvent (without gumming or lumping). Namely, the polar aprotic solution containing nanoscale silica, with surface hydroxyl groups, modified by a surface modification agent of the invention is an organic phase nanoscale silica solution.

The nanoscale silica, with surface hydroxyl groups, modified by a surface modification agent has a weight percentage of 20-60 wt %, preferably 30-60 wt %, based on the solid content of the polyamic acid resin composition.

It should be noted that the polar aprotic solution containing nanoscale silica, with surface hydroxyl groups, modified by the surface modification agent is prepared by the following steps. First, a nanoscale silica organic alcohol solution with surface hydroxyl groups react with a surface modification agent at 20-40° C. for 1-10 hr to obtain a result, wherein the surface modification agent has a weight percentage of 0.2-5 wt %, based on the nanoscale silica. Next, a polar aprotic solvent is added into the result forming a solution, wherein the nanoscale silica is uniformly and stably distributed in the polar aprotic solvent. Next, the organic alcohol of the solution is removed by vacuum distillation (a side product “water” can be removed simultaneously), to obtain the polar aprotic solution containing nanoscale silica, with surface hydroxyl groups, modified by the surface modification agent. Accordingly, the solvent of the nanoscale silica organic alcohol solution is replaced by the polar aprotic solvent, and the nanoscale silica is modified by the surface modification agent. It should be noted that, in the polar aprotic solution containing nanoscale silica, the nanoscale silica, with surface hydroxyl groups, modified by a surface modification agent is uniformly distributed in the polar aprotic solvent without gumming or lumping.

The alcohol solvent of the nanoscale silica organic alcohol solution includes methanol, ethanol, propanol, iso-propanol, butanol, iso-butanol, octanol, iso-octanol or combinations thereof.

The nanoscale silica organic alcohol solution with surface hydroxyl groups can preferably be a nanoscale silica isopropanol solution with surface hydroxyl groups, such as the isopropanol sol of silica disclosed in U.S. Pat. No. 5,902,226, U.S. Pat. No. 6,051,672, and TW Pat. 1308553.

It should be noted that the nanoscale silica organic alcohol solution with surface hydroxyl groups means that the nanoscale silica (with a particular size of 5-80 nm, preferably of 20-60 nm) is uniformly distributed in an organic alcohol without gumming or lumping. Please refer to the following patents: U.S. Pat. No. 5,902,226; U.S. Pat. No. 6,051,672; and TW Pat. 1308553.

The method for preparing the nanoscale silica organic alcohol solution with surface hydroxyl groups can include the following steps. First, a silicic acid (or polysilicic acid) is prepared by treating sodium silicate (water glass) with ion exchange resins. Next, the silicic acid (or polysilicic acid) is mixed with an organic alcohol steam (at a temperature of water boiling point to strip water steam), obtaining a complex. The complex can also be prepared by adding organic alcohol into a silicic acid (or polysilicic acid) aqueous solution. Next, the complex is added dropwisely into an aqueous phase silica seed material, obtaining the nanoscale silica organic alcohol solution with surface hydroxyl groups.

It should be noted that, neither the polar aprotic solution containing nanoscale silica, with surface hydroxyl groups, modified by a surface modification agent of the invention, nor the nanoscale silica organic alcohol solution with surface hydroxyl groups can be prepared simply by directly adding a nanoscale silica powder into a polar aprotic solvent or an organic alcohol solvent. This will be understood by a person of ordinary skill in the art, after reading the following paragraphs. In general, solid silica can be subjected to a physical treatment (such as ball milling) to maintain a nanoscale dimension. Since the nanoscale silica (solid phase) does not have surface hydroxyl groups, the nanoscale silica gathers together immediately causing a subsequent phase separation between the gathered nanoscale silica and the organic solvent, when directly adding the nanoscale silica into the organic solvent. Therefore, the nanoscale silica (solid phase) would not be uniformly distributed in an organic solvent.

The following examples are intended to illustrate the invention more fully without limiting their scope, since numerous modifications and variations will be apparent to those skilled in the art.

### Preparation Example 1

### Preparation of a Dmac Solution Containing Nanoscale Silica, with Surface Hydroxyl Groups, Modified by the Surface Modification Agent

100 g of iso-propanol sol of nanoscale silica having surface hydroxyl groups (sold and fabricated by Echochemical) (with a solid content of 20%), 1 g of N-phenyl-3-aminopropyltrimethoxysilane (serving as surface modification agent), and 80 g of DMAc were added into a 500 ml reaction bottle. After stirring at 40° C. for 6 hrs, iso-propanol and water (side-product) were removed using a vacuum distillation process and then 80 g of DMAc was added into the reaction bottle, obtaining a DMAc solution containing nanoscale silica, with surface hydroxyl groups, modified by the surface modification agent (with a solid content of 20%). After measuring by a dynamic light scattering method, an average silica particle size of 20 nm was recorded for the DMAc solution.

### Preparation Example 2

100 g of iso-propanol sol of nanoscale silica with surface hydroxyl groups (sold and fabricated by Echochemical) (with a solid content of 20%), 1 g of 3-aminopropyltrimethoxysilane (serving as surface modification agent), and 80 g of DMAc were added into a 500 ml reaction bottle. After stirring at 25° C. for 6 hrs, iso-propanol and water (side-product) were removed using a vacuum distillation process and then 80 g of DMAc was added into the reaction bottle, obtaining a DMAc solution containing nanoscale silica, with surface hydroxyl groups, modified by the surface modification agent (with a solid content of 20%). After measuring by a dynamic light scattering method, an average silica particle size of 40 nm was recorded for the DMAc solution.

### Preparation Example 3

100 g of iso-propanol sol of nanoscale silica with surface hydroxyl groups (sold and fabricated by Echochemical) (with a solid content of 20%), 1 g of 3-isocyanatepropyltriethoxysilane (serving as surface modification agent), and 80 g of DMAc were added into a 500 ml reaction bottle. After stirring at 24° C. for 6 hrs, iso-propanol and water (side-product) were removed using a vacuum distillation process and then 80 g of DMAc was added into the reaction bottle, obtaining a DMAc solution containing nanoscale silica, with surface hydroxyl groups, modified by the surface modification agent (with a solid content of 20%). After measuring by a dynamic light scattering method, an average silica particle size of 60 nm was recorded for the DMAc solution.

### Example 1

### Preparation of Polyamic Acid Resin

8.8225 g (0.0817 mole) of p-phenylene diamine (P-PDA), 7.002 g (0.0350 mole) of 4,4-oxydianiline (4,4-ODA), and 255 ml of N-methyl-2-pyrrolidone (NMP) were added into a 500 ml reaction bottle in a nitrogen atmosphere. After stirring, 16.4687 g (0.0560 mole) of 3,3,4,4-Biphenyl tetracarboylic dianhydride (s-BPDA) and 12.7203 g (0.0584 mole) of pyromellitic dianhydride (PMDA) were batchwisely added into the reaction bottle with a time interval of 30 min. After completely adding, the reaction bottle mixture was stirred for 3 hrs, obtaining a polyamic acid resin solution with a solid content of 15%. The obtained polyamic acid resin solution had a viscosity of 0.98d1/g according to a Ubbelohde viscometer.

### Examples 2-12

### Preparation of Polyamic Acid Resin Compositions (A)-(K)

The DMAc solutions disclosed in Preparation Examples 1-3 were selectively mixed with the polyamic acid resin solution disclosed in Example 1 according to Table 1 and 2 to prepare polyamic acid resin compositions (A)-(K) of Examples 2-12.

Measurement of Polyimide Films (A)-(K)

After stirring and defoaming, the polyamic acid resin compositions (A)-(K) were, respectively coated on PET (poly(ethylene terephthalate)) substrates. After pre-baking at 100° C. for 30 min, the obtained coating was peeled from the PET substrate, and then subjected to a thermal cyclopolymerization at 350° C. for 60 min, obtaining polyimide films (A)-(K), respectively.

Next, the thermal expansion coefficient, modulus, dimensional stability, transparency and hygroscopicity of the polyimide films (A)-(K) were measured as below. The results are shown in Tables 1 and 2.

Modulus

The modulus of polyimide films (A)-(K) were measured according to the IPC TM-650 2,4,19 test method. The polyimide test sample (1 cm×15 cm) was fixed in a materials testing machine (with a tensile speed of 25 mm/min) for measuring the tensile strength. The modulus was evaluated by the following:

modulus=S/ε(Kg/cm2)

S: tensile strength

ε: elongation

Dimensional Stability

The modulus of polyimide films (A)-(K) were measured according to the IPC-TM-650 2. 2. 4 test method. Firstly, a polyimide film supported on copper foil was cut into specimens having a size of 27 cm×29 cm. The specimen was punched four through holes having a diameter of 0.889 cm at its four corners each having a distance of 1.25 cm from the edge. Then the copper foil was etched and the distances between holes at mechanical direction (MD) and traverse direction (TD) were measured by dimension measuring apparatus. Subsequently, the specimen was placed and baked in an oven at a temperature of 150° C. for 30 minutes then stood at ambient temperature for 24 hours. The distances between holes at mechanical direction (MD) and traverse direction (TD) were measured again. The Dimensional stability was calculated from the measured MD distance and TD distance before and after backing.

The distance between two holes means the distance from the center of one hole to that of another hole. The first set and the second set holes in MD direction before baking were respectively referred to MD1 before baking and MD2 before baking, and those after baking were respectively referred to MD1 after baking and MD2 after baking. The first set and the second set holes in TD direction before baking were respectively referred to TD 1 before baking and TD2 before baking, and those after baking were respectively referred to TD1.sub.after baking and TD.sub.after baking. The dimensional change percentage was calculated from the following formula:

Dimensional change % in MD={[(MD1 after baking-MD1 before baking)/MD1 before baking]+[(MD2 after baking-MD2 before baking)/MD2 before baking]}/2×100

Dimensional change % in TD={[(TD1 after baking-TD1 before baking)/TD1 before baking]+[(TD2 after baking-TD2 before baking)/TD2 before baking]}/2×100

Transparency

The transparency (at 650 nm) of the polyimide films (A)-(K) was measured by UV/Vis spectrophotometer (HITACHI U-4001).

Hygroscopicity

The hygroscopicity of the polyimide films (A)-(K) were measured according to the IPC-TM-650 2.2.4 test method. First, the polyimide test sample (10 cm×10 cm) was baked at 110° C. for 60 min and had a weight W1. Next, the polyimide test sample was bathed in DI water for 24 hr. After drying, the obtained polyimide test sample had a weight W2. The hygroscopicity was evaluated by the following:

$$hygroscopicity ( \% ) = \frac{{W}_{2} - {W}_{1}}{{W}_{1}} \times 100$$

### Comparative Example 1

100 g of commercially available nanoscale inorganic silica powder (with a particular size of 20 nm, sold by Nanostructured & Amorphous Materials), 500 g of ethanol, and 5 g of N-phenyl-3-aminopropyltrimethoxysilane were added into a reaction bottle. After stirring, the mixture was heated from room temperature to 80° C. and then heated to reflux. After cooling and filtering, the result was washed by ethanol (or IPA) three times and then dried at 110° C. for 8 hr. Next, the result was mixed with the polyamic acid resin of Example 1 to prepare a polyamic acid resin composition with a silica solid content of 20 wt %. Next, the polyamic acid resin composition was coated on PET substrate, obtaining a polyimide film (L). Next, the thermal expansion coefficient, modulus, dimensional stability, transparency, and hygroscopicity of the polyimide film (L) was measured. The results are shown in Tables 1 and 2.

### Comparative Examples 2 and 3

The thermal expansion coefficient, modulus, dimensional stability, transparency, and hygroscopicity of the commercially available polyimide films Kapton E (sold by Du-Pont) and NPI (sold by Keneca) were measured. The results are shown in Tables 1 and 2.

TABLE 1

| | | | Example 2 | Example 3 | Example 4 | Example 5 | Example 6 | Example 7 | Example 8 |
|---|---|---|---|---|---|---|---|---|---|
| silica content | | | 0 wt % | 10 wt % | 30 wt % | 45 wt % | 60 wt % | 30 wt % | 45 wt % |
| | | | | (Preparation | (Preparation | (Preparation | (Preparaion | (Preparation | (Preparation |
| | | | | Example | Example | Example | Example | Example | Example |
| | | | | 1) | 1) | 1) | 1) | 2) | 2) |
| polyimide film No. | | | A | B | C | D | E | F | G |
| thermal expansion coefficient | | | 30.6 | 23.8 | 16.8 | 15.4 | 13.7 | 17.2 | 15.6 |
| (30-250° C.) | | | | | | | | | |
| modulus (Mpa) | | | 4100 | 5050 | 6800 | 7500 | 8200 | 6950 | 7750 |
| dimensional | 150° C. * 30 min | MD | −0.09 | −0.06 | −0.02 | −0.01 | 0.00 | −0.02 | −0.01 |
| stability | | TD | −0.10 | −0.04 | −0.01 | 0.00 | −0.01 | 0.00 | 0.00 |
| | 250° C. * 30 min | MD | −0.15 | −0.11 | −0.01 | 0.00 | 0.00 | −0.03 | −0.01 |
| | | TD | −0.12 | −0.09 | −0.02 | −0.02 | −0.01 | −0.01 | −0.02 |
| | 85° C. | MD | 0.18 | 0.12 | 0.05 | 0.05 | 0.02 | 0.06 | 0.05 |
| | 85% R.H | TD | 0.20 | 0.13 | 0.07 | 0.04 | 0.03 | 0.08 | 0.06 |
| | (96 hrs) | | | | | | | | |

| | | | | | | | |
|---|---|---|---|---|---|---|---|
| hygroscopicity (%) | 1.65 | 1.23 | 0.94 | 0.72 | 0.62 | 0.92 | 0.76 |
| transparency (%) | 80 | 82 | 83 | 85 | 86 | 82 | 83 |
| thickness (μm) | 26 | 26 | 26 | 26 | 26 | 26 | 26 |

TABLE 2

| | | | | Example | Example | Example | Comparative | Comparative | Comparative |
|---|---|---|---|---|---|---|---|---|---|
| | | | Example 9 | 10 | 11 | 12 | Example 1 | Example 2 | Example 3 |
| Silica content | | | 60 wt % | 30 wt % | 45 wt % | 60 wt % | 20 wt % | (Du-Pont) | (Keneca) |
| | | | (Preparation | (Preparation | (Preparation | (Preparation | | | |
| | | | Example 2) | Example 3) | Example 3) | Example 3) | | | |
| polyimide film No. | | | H | I | J | K | L | Kapton E | NPI |
| thermal expansion | | | 14.2 | 16.5 | 14.8 | 13.4 | 22.3 | 14.2 | 14.5 |
| coefficient (30-250° C.) | | | | | | | | | |
| modulus (Mpa) | | | 8300 | 6900 | 7950 | 8500 | 5120 | 5220 | 4850 |
| dimensional | 150° C. * 30 | MD | −0.01 | 0.00 | −0.01 | −0.01 | −0.03 | 0.04 | 0.02 |
| stability | min | TD | −0.02 | −0.02 | 0.00 | −0.02 | −0.02 | −0.03 | 0.00 |
| | 250° C. * 30 | MD | −0.03 | −0.03 | −0.03 | −0.04 | −0.08 | 0.04 | 0.05 |
| | min | TD | −0.01 | −0.01 | −0.02 | −0.02 | −0.06 | 0.01 | −0.06 |
| | 85° C. 85% | MD | 0.02 | 0.05 | 0.04 | 0.02 | 0.11 | 0.07 | 0.06 |
| | R.H (96 hrs) | TD | 0.04 | 0.08 | 0.05 | 0.03 | 0.09 | 0.05 | 0.08 |

| | | | | | | | |
|---|---|---|---|---|---|---|---|
| hygroscopicity (%) | 0.68 | 0.89 | 0.73 | 0.67 | 1.18 | 1.06 | 1.14 |
| transparency (%) | 85 | 81 | 83 | 83 | 68 | 82 | 81 |
| thickness (m) | 26 | 26 | 26 | 26 | 26 | 26 | 27 |

As shown in Tables 1 and 2, the polyimide film prepared from the polyamic acid resin composition exhibits superior modulus, hygroscopicity, dimensional stability, and high transparency, when the nanoscale silica, with surface hydroxyl groups, modified by a surface modification agent has a weight percentage of more than 30 wt %, based on the solid content of the polyamic acid resin composition. Further, the polyamic acid resin composition of the invention is different from the polyamic acid resin composition containing talc, mica or nanoscale silica powder modified by siloxane.

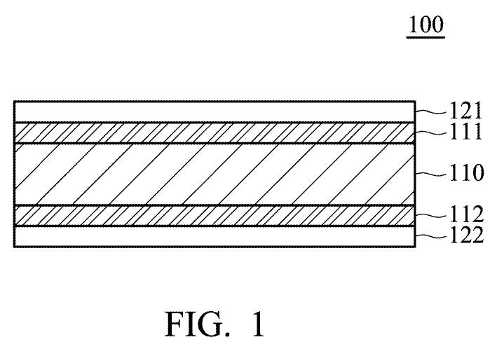

Referring to FIG. 1, a laminate (such as a double-sided flexible copper clad laminate 100) including the polyimide film of the invention is provided. The method for fabricating the double-sided flexible copper clad laminate 100 includes the following steps. First, a polyamic acid resin composition of the invention is coated on double sides of a heat-resistant polyimide substrate 110 (PI substrate). After baking at 250-350° C., polyimide films 111 and 112 are obtained. Finally, copper foils 121 and 122 are, respectively pasted on the polyimide films 111 and 112. After subjecting to a thermal lamination process (at a temperature of 320-350° C. and a pressure of 50-80 Kg/cm2 within 30 min (preferably 5-20 min), the double-sided flexible copper clad laminate 100 is obtained.

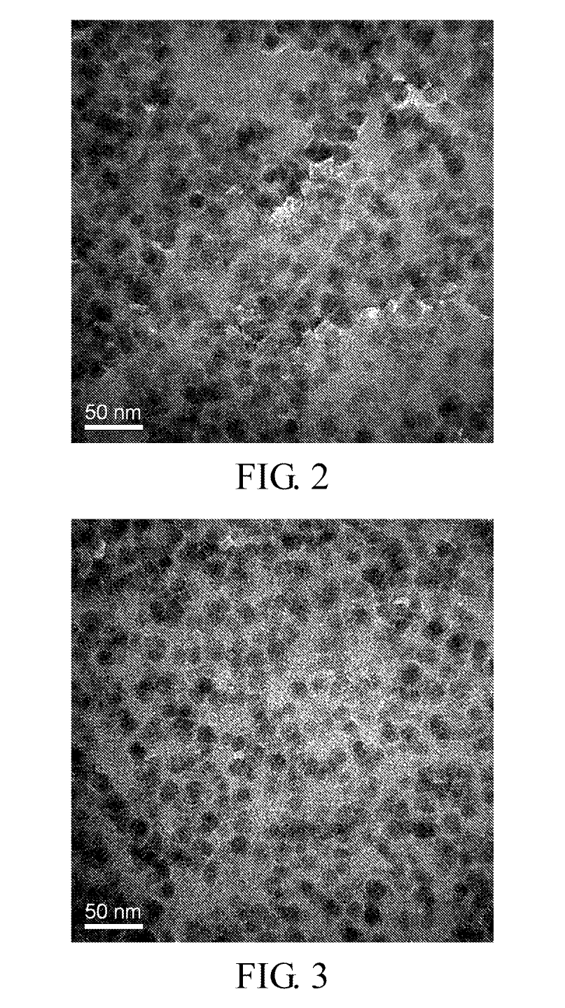

FIG. 2 shows a transmission electron microscope spectrum of a polyimide film fabricated by curing a polyamic acid resin composition which was prepared by mixing an unmodified silica (such as N-phenyl-3-aminopropyltrimethoxysilane) with a polyamic acid resin.

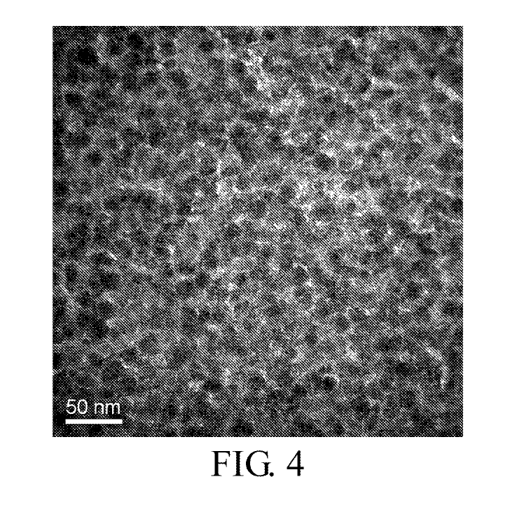

Further, FIGS. 3 and 4 are transmission electron microscope spectrums of a polyimide films fabricated, respectively by curing polyamic acid resin compositions of Examples 4 and 6. Accordingly, the polyimide films fabricated by the composition of Examples 4 and 6 provide a uniform nanoscale silica distribution.

Accordingly, the invention provides a polyamic acid resin composition including a polar aprotic solution containing nanoscale silica, with surface hydroxyl groups, modified by a surface modification agent. The above polar aprotic solution is prepared by the following. A nanoscale silica organic alcohol solution with surface hydroxyl groups is reacted with a surface modification agent to obtain a result. Next, a polar aprotic solvent is added into the result to form a solution, wherein the nanoscale silica is uniformly and stably distributed in the polar aprotic solvent. Next, the organic alcohol of the solution is removed by vacuum distillation, to obtain the polar aprotic solution containing nano scale silica, with surface hydroxyl groups, modified by the surface modification agent. The polyamic acid resin composition is subjected to a thermal cyclopolymerization process to form a polyimide film. The polyimide film of the invention exhibits high transparency and has high silica content (achieving about 60 wt %, based on the solid content of the polyamic acid resin). Further, the polyimide film of the invention also exhibits superior modulus, dimensional stability, and hygroscopicity in comparison with prior arts, thereby meeting the requirements for electronic packages with high integration and low occupancy (pitch<40 μm).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polyamic acid resin composition, comprising:
a polyamic acid resin;
a solvent; and
a polar aprotic solution containing nanoscale silica, with surface hydroxyl groups, modified by a surface modification agent, wherein the nanoscale silica, with surface hydroxyl groups, modified by a surface modification agent is uniformly distributed in a polar aprotic solvent and has an average particular size of 5-80 nm, wherein the surface modification agent has a structure represented by formula (I):
R¹—Si—(OR²)₃ formula (I)
wherein, R¹ is an aliphatic group or an aromatic group, and R² is a C₁₋₈ alkyl group.

2. The polyamic acid resin composition as claimed in claim 1, wherein the polar aprotic solution comprises γ-butyrolactone, N-methyl-2-pyrrolidone, or N,N-dimethylacetamide.

3. The polyamic acid resin composition as claimed in claim 1, wherein R¹ is a C₁₋₁₈ alkyl group, C₂₋₁₈ alkynylene group, C₂₋₁₈ alkenyl group, C₁₋₈ alkoxy group, C₂₋₁₈ ether group, C₁₋₁₈ alkylamino group, C₁₋₁₈ alkylthio group, C₂₋₁₈ isocyanate group, C₃₋₁₈ heteroalkyl group, C₃₋₂₀ aryl group, C₃₋₂₀ heteroaryl group, C₃₋₂₀ cycloaliphatic group, or C₃₋₂₀ cycloalkyl group.

4. The polyamic acid resin composition as claimed in claim 1, wherein the surface modification agent comprises propyltrimethoxysilane, propyltriethoxysilane, isobutyltrimethoxysilane, isobutyltriethoxysilane, octyltrimethoxysilane, octyltriethoxysilane, octadecyltrimethoxysilane, octadecyltriethoxysilane, N-phenyl-3-aminopropyltrimethoxysilane, phenyltrimethoxysilane, phenyltriethoxysilane, trimethoxysilylethylene, triethoxysilylethylene, allyltrimethoxysilane, allyltriethoxysilane, 3-glycidoxypropyltrimethoxysilane, 3-glycidoxypropyltriethoxysilane, 3-aminopropyltrimethoxysilane, 3-aminopropyltrimethoxysilane, aminoethylaminopropyltrimethoxysilane, aminoethylaminopropyltriethoxysilane, 3-isocyanatepropyltrimethoxysilane, or 3-isocyanatepropyltriethoxysilane).

5. The polyamic acid resin composition as claimed in claim 1, wherein the nanoscale silica, with surface hydroxyl groups, modified by a surface modification agent has an average particular size of 20-60 nm.

6. The polyamic acid resin composition as claimed in claim 1, wherein the nanoscale silica, with surface hydroxyl groups, modified by a surface modification agent has a weight percentage of 30-60 wt %, based on the solid content of the polyamic acid resin composition.

7. The polyamic acid resin composition as claimed in claim 1, wherein the polar aprotic solution containing nanoscale silica, with surface hydroxyl groups, modified by the surface modification agent comprises products prepared by the following steps:
reacting a nanoscale silica organic alcohol solution with surface hydroxyl groups with the surface modification agent to prepare the nanoscale silica organic alcohol solution, with surface hydroxyl groups, modified by the surface modification agent; and
replacing an alcohol solvent of the nanoscale silica organic alcohol solution, with surface hydroxyl groups, modified by the surface modification agent with a polar aprotic solution using vacuum distillation, to obtain the polar aprotic solution containing nanoscale silica, with surface hydroxyl groups, modified by the surface modification agent.

8. The polyamic acid resin composition as claimed in claim 1, wherein the surface modification agent has a weight percentage of 0.2-5 wt %, based on the nanoscale silica.

9. The polyamic acid resin composition as claimed in claim 7, wherein the alcohol solvent comprises methanol, ethanol, propanol, iso-propanol, butanol, iso-butanol, octanol, or iso-octanol.

10. The polyamic acid resin composition as claimed in claim 7, wherein the nanoscale silica organic alcohol solution with surface hydroxyl groups comprises an nanoscale silica isopropanol solution with surface hydroxyl groups.

11. The polyamic acid resin composition as claimed in claim 1, wherein the polyamic acid resin is prepared by reacting a dianhydride monomer with a diamine monomer.

12. The polyamic acid resin composition as claimed in claim 11, wherein the dianhydride monomer is selected from a group consisting of pyromellitic dianhydride, 3,3,4,4-Biphenyl tetracarboylic dianhydride, s-BPDA), 1,4,5,8-Naphthalenetetracarboxylicdianhydride, 3,3,4,4-benzophenone -tetracarboxylic dianhydride, 4,4-oxydiphthalic anhydride, hydroquinnone diphtalic anhydride, 4,4-bisphenol A dianhydride, 2,2-bis -(3,4-dicarboxyphenyl)hexafluoropropane dianhydride, 1,3-dihydro-1,3-dioxo-5-isobenzofurancarboxylic acid phenylene ester, 3,3,4,4-Diphenylsulfone tetracarboxylic dianhydride and combinations thereof.

13. The polyamic acid resin composition as claimed in claim 11, wherein the diamine monomer is selected from a group consisting of p-phenylene diamine, 4,4-oxydianiline, 3,4-Oxydianiline, 3,3′-dihydroxy-4,4-diamino-biphenyl, 4,4-diaminodiphenyl sulfone, 2,2-bis(4-aminophenyl)hexa-fluoropropane, 2,2-Bis(4-[4-aminophenoxy]phenyl)propane, 2,2-Bis(4-[3-aminophenoxy]phenyl)sulfone, 1,4-Bis(4-aminophenoxy)benzene, 1,3-Bis(4-aminophenoxy)benzene, 1,3-Bis(3-aminophenoxy)benzene, 4,4-Bis(4-aminophenoxy)biphenyl, 1,4-Bis(4-aminophenoxy)-2,5-di-t-butylbenzene, 4,4-B is (4-aminophenoxy)benz ophenone, diamino siloxane and combinations thereof.

14. The polyamic acid resin composition as claimed in claim 1, wherein the solvent comprises N-methyl-2-pyrrolidone, N,N-dimethylacetamide, γ-butyrolactone or combinations thereof.

15. The polyamic acid resin composition as claimed in claim 1, wherein the solvent is a co-solvent comprising xylene and toluene.

16. A polyimide film obtained by reacting components of a polyamic acid resin composition using an imidization process, where the polyamic acid resin composition comprises:
a polyamic acid resin;
a solvent; and
a polar aprotic solution containing nanoscale silica, with surface hydroxyl groups, modified by a surface modification agent, wherein the nanoscale silica, with surface hydroxyl groups, modified by a surface modification agent is uniformly distributed in a polar aprotic solvent and has an average particular size of 5-80 nm, wherein the surface modification agent has a structure represented by formula (I):
R¹—Si—(OR²)₃ formula (I)
wherein, R¹ is an aliphatic group or an aromatic group, and R² is a C₁₋₈ alkyl group.

17. The polyimide film as claimed in claim 16, wherein the polyimide film serves as a protection film of an electronic device.

18. A laminate comprising the polyimide film as claimed in claim 16.

19. The laminate as claimed in claim 18, wherein the polyimide film is disposed on a polymer film, copper foil, aluminium foil, stainless foil or nickel foil.

20. The laminate as claimed in claim 18, wherein the laminate is a copper foil laminate.

21. The laminate as claimed in claim 18, wherein the laminate is a double-sided flexible copper clad laminate.
